(19) United States
(12) Patent Application Publication
(10) Pub. No.: US 2015/0267896 A1
(43) Pub. Date: Sep. 24, 2015

(54) LED BULB WITH LARGE LIGHT-EMITTING ANGLE AND METHOD FOR MANUFACTURING THE SAME

(71) Applicants: Daisung Moon, Seoul (KR); Sangpil Moon, Seoul (KR)

(72) Inventors: Daisung Moon, Seoul (KR); Sangpil Moon, Seoul (KR)

(21) Appl. No.: 14/357,564

(22) PCT Filed: Mar. 21, 2014
(86) PCT No.: PCT/CN2014/073810

§ 371 Date: May 10, 2014

(51) Int. Cl. F21V 7/16; F21V 19/00

(52) U.S. Cl. CPC F21V 7/16; F21V 19/003; F21Y 2101/02

(57) ABSTRACT

The invention relates to a LED bulb with large light-emitting angle and a method for manufacturing the same. The LED bulb with large light emitting angle comprises a lamp cap, a lamp base, an aluminum substrate, a lamp body and a lamp cover sequentially connected as an entity, an elastically deformable and recoverable reflector is arranged on the aluminum substrate. The reflector is an integrally-formed piece composed of a cylinder and a trumpet-shaped piece. An outer diameter of the reflector is bigger than an inner diameter of the lamp cover. The method for manufacturing a LED bulb with large light emitting angle comprises the following steps before fastening the lamp cover to the lamp body: squeezing a reflector, putting the reflector into the lamp cover, fixing the reflector to the aluminum substrate, and recovering the reflector to its initial shape through its own elasticity.

### FIELD OF THE INVENTION

The invention relates to a LED bulb with large light-emitting angle and a method for manufacturing the same.

### BACKGROUND OF THE INVENTION

Existing LED bulb with a reflector for directing light downwards will limit the light-emitting angle of the LED bulb to about 240 degrees, and it's hard to enlarge the angle to over 300 degrees because it's difficult to assemble the LED bulb if the reflector has a large outer diameter.

Referring to FIG. 3 and FIG. 4, if an outer diameter ( [symbol] B) of the reflector is bigger than an inner diameter ( [symbol] A) of a lamp cover, it's impossible to assemble the reflector inside the lamp cover, because the reflector cannot get into the lamp cover. Since the outer diameter of the reflector for directing light downwards is so small, the light-reflecting area is limited, a larger light-reflecting angle is hardly possible.

### SUMMARY OF THE INVENTION

The purpose of the present invention is to provide a LED bulb with large light-emitting angle and a method for manufacturing the same. The LED bulb with large light-emitting angle is realized by putting an elastically deformable and recoverable reflector inside a lamp cover, when the reflector returns to its initial shape it will enlarge the reflecting area, which can bring an over-300-degree light emitting angle.

The technical solution of the present invention is a LED bulb with large light-emitting angle comprising a lamp cap, a lamp base, an aluminum substrate, a lamp body and a lamp cover sequentially connected as an entity, characterized in that: an elastically deformable and recoverable reflector is arranged on the aluminum substrate.

In a preferred embodiment, an outer diameter of the reflector is bigger than an inner diameter of a connection part of the lamp cover, the connection part of the lamp cover being fastened to an end of the lamp body.

In a preferred embodiment, the reflector is an integrally-formed piece composed of a cylinder and a trumpet-shaped piece arranged on the cylinder.

In a preferred embodiment, two symmetrically-arranged protrusions radially protrude from the cylinder, with the protrusion having a screw hole therein.

In a preferred embodiment, a plurality of bar-shaped slots offering space for deformation are recessed from an edge of the trumpet-shaped piece.

In a preferred embodiment, the plurality of bar-shaped slots divide the trumpet-shaped piece into a plurality of interconnected petal-like pieces.

In a preferred embodiment, the reflector is made of elastic material, after the petal-like pieces with a deformed shape have been assembled on the aluminum substrate inside the lamp cover by squeezing the trumpet-shaped piece, the petal-like pieces will recover to their initial shape, owing to elasticity of the petal-like pieces.

Another technical solution of the present invention is a LED bulb with large light-emitting angle, which comprises a lamp cap, a lamp base, an aluminum substrate, a lamp body and a lamp cover sequentially connected as an entity; characterized in that: an elastically deformable and recoverable reflector is arranged on the aluminum substrate; an outer diameter of the reflector is bigger than an inner diameter of an connection part of the lamp cover, the connection part of the lamp cover being fastened to an end of the lamp body; the reflector is an integrally-formed piece composed of a cylinder and a trumpet-shaped piece arranged on the cylinder; two symmetrically-arranged protrusions radially protrude from the cylinder, with the protrusion having a screw hole therein; a plurality of slots offering space for deformation are recessed from an edge of the trumpet-shaped piece; the plurality of slots divide the trumpet-shaped piece into a plurality of interconnected petal-like pieces; and the reflector is made of elastic material, after the petal-like pieces with a deformed shape have been assembled on the aluminum substrate inside the lamp cover by squeezing the trumpet-shaped piece, the petal-like pieces will recover to their initial shape, owing to elasticity of the petal-like pieces.

Another technical solution of the present invention is a method for manufacturing a LED bulb with large light-emitting angle, comprising sequentially connecting a lamp cap, a lamp base having a driver board and a stopper therein, an aluminum substrate, a lamp body and a lamp cover together as an entity, characterized in that, the following steps are performed prior to fastening the lamp cover to the lamp body: squeezing a reflector, putting the reflector into the lamp cover, fixing the reflector to the aluminum substrate by screwing two screws into two screw holes respectively opened in two symmetrically-arranged protrusions at a bottom of a cylinder of the reflector and two screw holes opened in the aluminum substrate and positioned right below the screw holes of the reflector, and recovering the reflector to its initial shape through its own elasticity.

In an preferred embodiment, the reflector is an integrally-formed piece composed of a cylinder and a trumpet-shaped piece arranged on the cylinder; an outer diameter of the reflector is bigger than an inner diameter of a connection part of the lamp cover, the connection part of the lamp cover being fastened to an end of the lamp body; a plurality of bar-shaped slots offering space for deformation are recessed from an edge of the trumpet-shaped piece; the plurality of bar-shaped slots divide the trumpet-shaped piece into a plurality of interconnected petal-like pieces; the reflector is made of elastic material, after the petal-like pieces with a deformed shape have been assembled on the aluminum substrate inside the lamp cover by squeezing the trumpet-shaped piece, the petal-like pieces w recover to their initial shape, owing to elasticity of the petal-like pieces.

Compared with prior art, the LED bulb with large light-emitting angle and the method for manufacturing the same of the present invention have the following advantages:

(1) By using a reflector whose outer diameter is bigger than the inner diameter of the lamp cover, the method of the invention resolves the technical problem that existing LED bulb with a traditional reflector directing light downward cannot obtain a light emitting angle greater than 240 degrees.

(2) Since the reflector can recover from elastic deformation, after it was assembled inside the lamp cover, it can return to its initial shape, hence it can increase the reflecting area so as to realize an over-300-degree light emitting angle.

(3) The increase of the outer diameter of the reflector directing light downwards brings a bigger reflecting area; it's thus possible to obtain a larger reflecting angle.

### BRIEF DESCRIPTION OF THE DRAWINGS

FIG. 1 is a cross sectional view of an assembled LED bulb of present invention.

FIG. 2 is a top plan view of a reflector of the LED bulb shown in FIG. 1.

FIG. 3 is a cross sectional view of an assembled LED bulb of prior art.

FIG. 4 is a top plan view of a reflector of the LED bulb shown in FIG. 3.

### DETAILED DESCRIPTION OF ILLUSTRATED EMBODIMENTS

Various preferred embodiments will now be described with reference to the figures.

Referring to FIG. 1, a LED bulb comprises a lamp cap 1, a lamp base 2, an aluminum substrate 3, a lamp body 4 and a lamp cover 5 sequentially connected as an entity, wherein, an elastically deformable and recoverable reflector 6 is arranged on the aluminum substrate 3.

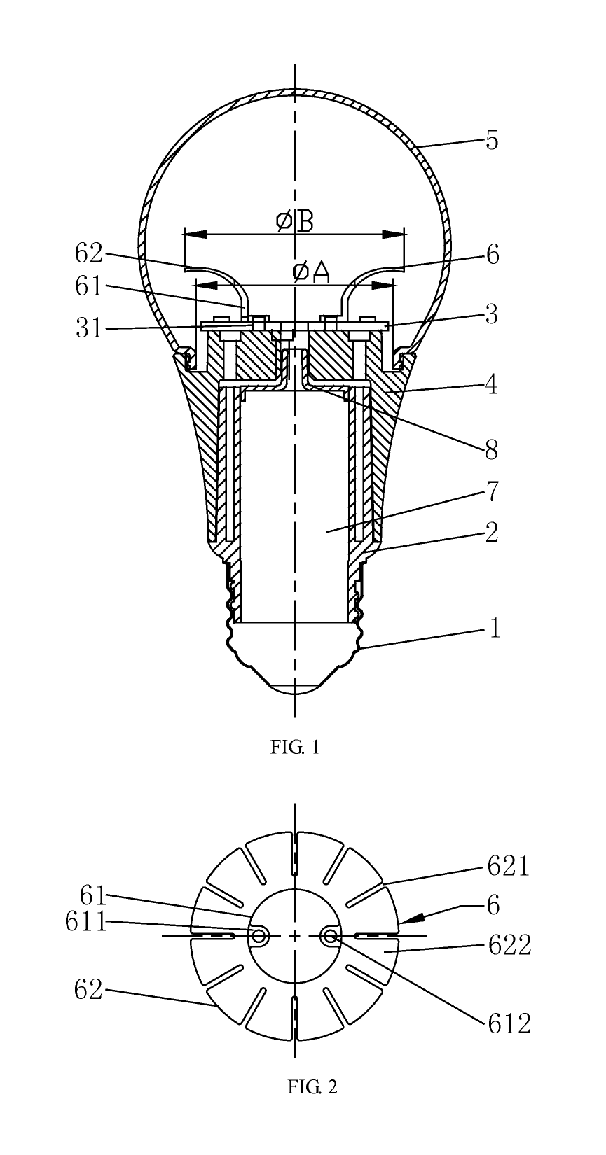

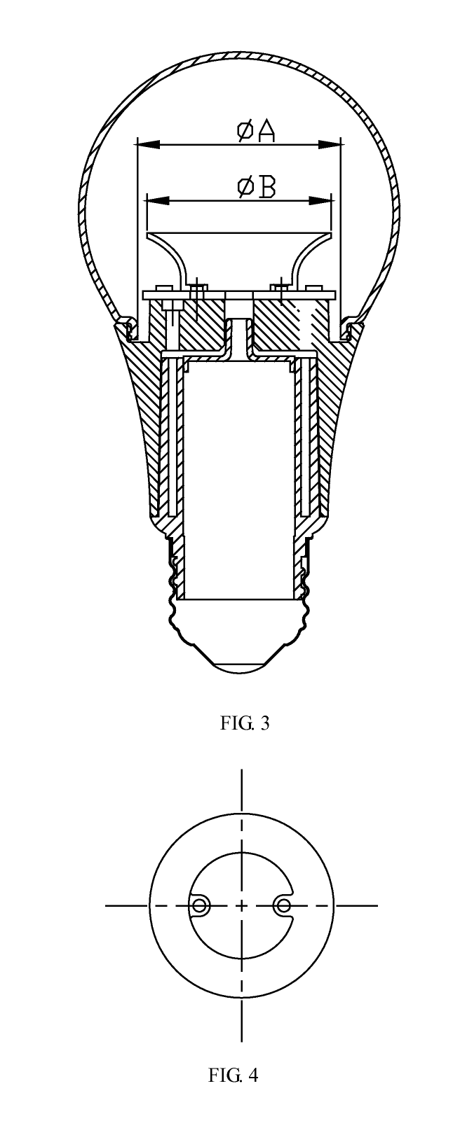

Referring to FIG. 2, the reflector 6 comprises a cylinder 61, two symmetrically-arranged protrusions 611 radially protruding from the cylinder 61 with the protrusion 611 having a screw hole 612 therein, a trumpet-shaped piece 62 arranged on the cylinder 61 and integrally-formed with the cylinder 61, a plurality of bar-shaped slots 621 offering space for deformation recessed from an edge of the trumpet-shaped piece 62, a plurality of interconnected petal-like pieces 622 formed as the consequence of the plurality of bar-shaped slots 621 dividing the trumpet-shaped piece 62 into pieces. An outer diameter of the reflector 6 is bigger than an inner diameter of a connection part of the lamp cover 5, the connection part of the lamp cover 5 being fastened to an end of the lamp body 4.

In this embodiment, the reflector 6 is made of elastic material, after the petal-like pieces 622 with a deformed shape have been assembled on the aluminum substrate 3 inside the lamp cover 5 by squeezing the trumpet-shaped piece 62, the petal-like pieces 622 will recover to their initial shape, owing to elasticity of the petal-like pieces.

Referring to FIG. 1, a method for manufacturing a LED bulb with large light-emitting angle comprises sequentially connecting a lamp cap 1, a lamp base 2 having a driver board 7 and a stopper 8 therein, an aluminum substrate 3, a lamp body 4 and a lamp cover 5 together as an entity, the following steps are performed prior to fastening the lamp cover 5 to the lamp body 4: squeezing a reflector 6, putting the reflector 6 into the lamp cover 5, fixing the reflector 6 to the aluminum substrate 3 by screwing two screws into two screw holes 612 respectively opened in two symmetrically-arranged protrusions 611 at a bottom of a cylinder 61 of the reflector 6 and two screw holes 31 opened in the aluminum substrate 3 and positioned right below the screw holes 612 of the reflector 6, and recovering the reflector 6 to its initial shape through its own elasticity; thereby obtaining an over-300-degree reflecting angle for downwards directed light.

In this embodiment, the reflector 6 comprises an integrally-formed cylinder 61 and a trumpet-shaped piece 62, wherein the trumpet-shaped piece 62 is arranged on the cylinder 61; an outer diameter of the reflector 6 is bigger than an inner diameter of a connection part of the lamp cover 5, the connection part of the lamp cover 5 being fastened to an end of the lamp body 4; a plurality of bar-shaped slots 621 offering space for deformation are recessed from an edge of the trumpet-shaped piece 62; the plurality of bar-shaped slots 621 divide the trumpet-shaped piece 62 into a plurality of interconnected petal-like pieces 622; the reflector 6 is made of elastic material, after the petal-like pieces 622 with a deformed shape have been assembled on the aluminum substrate 3 inside the lamp cover 5 by squeezing the trumpet-shaped piece 622, the petal-like pieces 622 will recover to their initial shape, owing to elasticity of the petal-like pieces 622.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention.

1. A LED bulb with large light-emitting angle, comprising a lamp cap, a lamp base, an aluminum substrate, a lamp body and a lamp cover sequentially connected as an entity, characterized in that: an elastically deformable and recoverable reflector is arranged on the aluminum substrate.

2. The LED bulb as claimed in claim 1, characterized in that: an outer diameter of the reflector is bigger than an inner diameter of a connection part of the lamp cover, the connection part of the lamp cover being fastened to an end of the lamp body.

3. The LED bulb as claimed in claim 2, characterized in that: the reflector is an integrally-formed piece composed of a cylinder and a trumpet-shaped piece arranged on the cylinder.

4. The LED bulb as claimed in claim 3, characterized in that: two symmetrically-arranged protrusions radially protrude from the cylinder, with the protrusion having a screw hole therein.

5. The LED bulb as claimed in claim 3, characterized in that: a plurality of bar-shaped slots offering space for deformation are recessed from an edge of the trumpet-shaped piece.

6. The LED bulb as claimed in claim 5, characterized in that: the plurality of bar-shaped slots divide the trumpet-shaped piece into a plurality of interconnected petal-like pieces.

7. The LED bulb as claimed in claim 6, characterized in that: the reflector is made of elastic material, after the petal-like pieces with a deformed shape have been assembled on the aluminum substrate inside the lamp cover by squeezing the trumpet-shaped piece, the petal-like pieces will recover to their initial shape, owing to elasticity of the petal-like pieces.

8. A LED bulb with large light-emitting angle, comprising a lamp cap, a lamp base, an aluminum substrate, a lamp body and a lamp cover sequentially connected as an entity, characterized in that:
an elastically deformable and recoverable reflector is arranged on the aluminum substrate;
an outer diameter of the reflector is bigger than an inner diameter of an connection part of the lamp cover, the connection part of the lamp cover being fastened to an end of the lamp body;
the reflector is an integrally-formed piece composed of a cylinder and a trumpet-shaped piece arranged on the cylinder;
two symmetrically-arranged protrusions radially protrude from the cylinder, with the protrusion having a screw hole therein;
a plurality of bar-shaped slots offering space for deformation are recessed from an edge of the trumpet-shaped piece;
the plurality of bar-shaped slots divide the trumpet-shaped piece into a plurality of interconnected petal-like pieces; and
the reflector is made of elastic material, after the petal-like pieces with a deformed shape have been assembled on the aluminum substrate inside the lamp cover by squeezing the trumpet-shaped piece, the petal-like pieces will recover to their initial shape, owing to elasticity of the petal-like pieces.

9. A method for manufacturing a LED bulb with large light-emitting angle, comprising sequentially connecting a lamp cap, a lamp base having a driver board and a stopper therein, an aluminum substrate, a lamp body and a lamp cover together as an entity, characterized in that, the following steps are performed prior to fastening the lamp cover to the lamp body:
squeezing a reflector,
putting the reflector into the lamp cover,
fixing the reflector to the aluminum substrate by screwing two screws into two screw holes respectively opened in two symmetrically-arranged protrusions at a bottom of a cylinder of the reflector and two screw holes opened in the aluminum substrate and positioned right below the screw holes of the reflector, and
recovering the reflector to its initial shape through its own elasticity.

10. The method as claimed in claim 9, characterized in that,
the reflector is an integrally-formed piece composed of the cylinder and a trumpet-shaped piece arranged on the cylinder;
an outer diameter of the reflector is bigger than an inner diameter of a connection part of the lamp cover, the connection part of the lamp cover being fastened to an end of the lamp body;
a plurality of bar-shaped slots offering space for deformation are recessed from an edge of the trumpet-shaped piece;
the plurality of bar-shaped slots divide the trumpet-shaped piece into a plurality of interconnected petal-like pieces; and
the reflector is made of elastic material, after the petal-like pieces with a deformed shape have been assembled on the aluminum substrate inside the lamp cover by squeezing the trumpet-shaped piece, the petal-like pieces will recover to their initial shape, owing to elasticity of the petal-like pieces.
